(19) United States
(12) Patent Application Publication
(10) Pub. No.: US 2015/0170208 A1
(43) Pub. Date: Jun. 18, 2015

(54) SIMULTANEOUS COMMERCIAL PROVISION TO CONTENT CONSUMPTION DEVICES CONSUMING SAME AS WELL AS DIFFERENT MEDIA CONTENT

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 14/104,840

(22) Filed: Dec. 12, 2013

(51) Int. Cl. G06Q 30/02

(52) U.S. Cl. CPC G06Q 30/0264

(57) ABSTRACT

Apparatuses, methods and storage medium associated with content consumption are disclosed herein. In embodiments, an apparatus may include a commercial engine. The commercial engine may be configured to transmit or cause to be transmitted, e.g., by a content provision engine, at an appointed time of a first of the plurality of time zones, a commercial message to at least the content consumption devices of the content consumers currently located in a second time zone. The transmission may be irrespective of whether the content consumers of the content consumption devices to receive the commercial message are consuming the same or different content from one or more media content distribution systems. Other embodiments may be described and/or claimed.

### TECHNICAL FIELD

The present disclosure relates to the field of data processing, in particular, to apparatuses, methods and storage medium associated with simultaneous commercial provision.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multi-media contents, and their consumption through public networks, such as the Internet. Ever since the advance of the Internet and the World Wide Web, advertisers have been focused on targeting online advertisements. For examples, Internet portals have put much effort into targeting the banner advertisements (Ads), based on the content of the web pages being browsed; and search engines have put much effort into targeting advertisements based on keywords. Recently, social networks have put their effort into targeting advertisements based on social graphs. In these and other efforts, the focus has generally been learning about interests and locations of the content consumers, and their demographics, such that highly targeted, or even personalized, Ads may be delivered to the individual content consumers.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for content distribution and consumption, incorporated with the simultaneous commercial provision teachings of the present disclosure, in accordance with various embodiments.

FIG. 2 illustrates an example content stream in further detail, in accordance with various embodiments.

FIG. 3 illustrates an example process for simultaneous commercial provision, in accordance with various embodiments.

FIG. 4 illustrates an example computing environment suitable for practicing the present disclosure, in accordance with various embodiments.

FIG. 5 illustrates an example storage medium with instructions configured to cause an apparatus to practice the present disclosure, in accordance with various embodiments.

### DETAILED DESCRIPTION

Apparatuses, methods and storage medium associated with simultaneous commercial provision are disclosed herein. Inventors of the present disclosure have discovered that the continuing pursuit of highly targeted, or even personalized, online advertisement, may not be the most cost effective way for delivering online advertisements. Increasingly, content consumers are concerned about the lost of privacy, as content providers/facilitators and online advertisers insatiably attempt to learn about the demographics, interests and whereabouts of the content consumers.

In embodiments, a content distribution system may include a content provision engine configured to stream a plurality of multi-media content, via one or more networks, to a plurality of content consumption devices of a plurality of content consumers currently located in a plurality of time zones. The same or a different apparatus may further include a commercial engine coupled with the content provision engine, and configured to transmit or cause the content provision engine to transmit, at an appointed time of a first of the plurality of time zones, a commercial message to at least the content consumption devices of the content consumers currently located in a second time zone, irrespective of whether the content consumers of the content consumption devices to receive the commercial message are consuming the same or different content, from the same or different content distribution system. In embodiments, the commercial message is transmitted irrespective of the demographics and/or interests of the content consumers.

In embodiments, the commercial engine may gather and report viewership of the commercial message, to a sponsor of the commercial message, such as an advertiser, or an advertising agent. In embodiments, the commercial engine may invoice sponsor based on the viewership gathered and reported after the transmission. In other embodiments, the commercial engine may publish historic viewership of the appointed time, and auction the appointed time to one of a plurality of sponsors.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. The terms “commercial” and “advertisement” as used herein may be considered synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

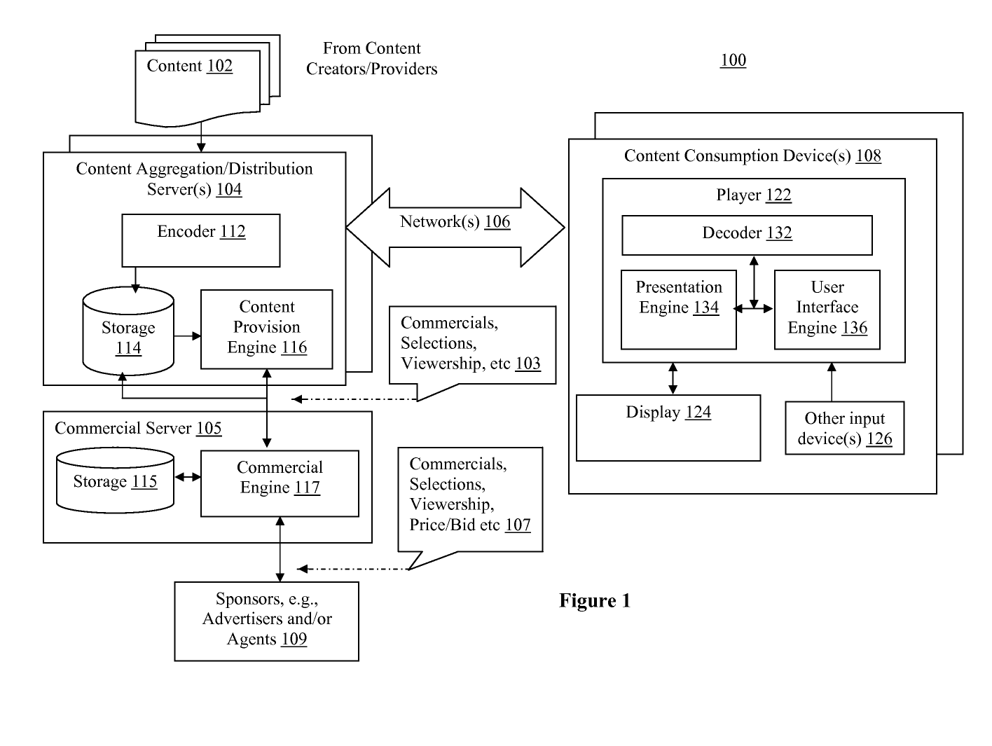

Referring now FIG. 1, wherein an arrangement for content distribution and consumption, incorporated with the simultaneous commercial provision teachings of the present disclosure, in accordance with various embodiments, is illustrated. As shown, in embodiments, arrangement 100 for distribution and consumption of content may include a number of content consumption devices 108 coupled with one or more content aggregation/distribution servers 104 via one or more networks 106. The one or more content aggregation/distribution servers 104 may in turn be coupled with commercial server 105, directly as shown, or via one or more networks 106. Each content aggregation/distribution server 104 may include content provision engine 116 configured to distribute contents to content consumption devices 108 for consumption, via one or more networks 106. Further, commercial server 105 may include commercial engine 117. As will be described in more detail below, in embodiments, commercial engine 117 may be incorporated with various teachings of the present disclosure to cause content provision engine 116 to simultaneously provide, at one or more appointed times, one or more online commercial messages to various content consumption devices 108, irrespective of the content being consumed using the various content consumption devices 108. In alternate embodiments, commercial engine 117 may simultaneously provide, at one or more appointed times, one or more online commercial messages to various content consumption devices 108, irrespective of the content being consumed using the various content consumption devices 108. In embodiments, the simultaneous distribution may be coordinated with sibling, other affiliated distribution systems, e.g., different branded media content distribution systems/channels owned/operated by an entity, a partnership or an alliance. Resultantly, cost effectiveness of online commercials, and user experience may be potentially enhanced.

In embodiments, as shown, content aggregation/distribution servers 104, in addition to content provision engine 116, may include encoder 112 and storage 114, coupled to each other, and to content provision engine 116 as shown. Encoder 112 may be configured to encode contents 102 from various content providers, and storage 114 may be configured to store encoded content. Content provision engine 116 may be configured to selectively retrieve and stream encoded content to the various content consumption devices 108 in response to requests from the various content consumption devices 108. As earlier described, in embodiments, content provision engine 116 may also be configured to simultaneously provide at one or more appointed times, in response to commercial engine 117, one or more online commercial messages to various content consumption devices 108, irrespective of the content being consumed using the various content consumption devices 108. For these embodiments, storage 114 may also be configured to store the commercial messages, appointed time selections, and related information.

Contents 102 may be multi-media contents of various types, having video, audio, and/or closed captions, from a variety of content creators and/or providers. Examples of contents may include, but are not limited to, movies, TV programming, user created contents (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In embodiments, for efficiency of operation, encoder 112 may be configured to transcode the various contents 102, typically in different encoding formats, into a subset of one or more common encoding formats. Encoding of audio data may be performed in accordance with, e.g., but are not limited to, the MP3 standard, promulgated by the Moving Picture Experts Group (MPEG). Encoding of video and/or audio data may be performed in accordance with, e.g., but are not limited to, the H264 standard, promulgated by the International Telecommunication Unit (ITU) Video Coding Experts Group (VCEG).

Storage 114 may include temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

Content provision engine 116 may, in various embodiments, be configured to provide encoded content as discrete files and/or as continuous streams of encoded content. Content provision engine 116 may be configured to transmit the compressed audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth.

Commercial server 105, in addition to commercial engine 117 may further include storage 115 coupled with commercial engine 117 as shown. Storage 115 may be configured to store various commercial messages, appointed time selections, and related information. Similar to storage 114, storage 115 may include temporal and/or persistent storage of any type, including, but are not limited to, volatile and non-volatile memory, optical, magnetic and/or solid state mass storage, and so forth.

Commercial engine 117, as earlier described, may be configured to control content provision engine 116 to simultaneously provide, at an appointed time of a time zone, e.g., the eastern time zone of the U.S., one or more commercial messages, such as advertisements, to content consumption devices 108 of one or more time zones, irrespective of the whether the content being consumed by the content consumption devices 108 of the one or more time zones, are the same or different. In embodiments, the one or more commercial messages may be simultaneously provided without regard to the demographics and/or interests of the content consumers associated with the content consumption devices 108. In embodiments, the commercial messages may include multi-media contents. In embodiments, the simultaneous distribution may be coordinated with sibling, other affiliated distribution systems.

In embodiments, the one or more commercials may be simultaneously provided to content consumption devices 108 of the time zone. In other embodiments, the one or more commercials may be simultaneously provided to content consumption devices 108 of at least one other adjacent time zone, e.g., the central time zone of the U.S., adjacent to the eastern time zone. In embodiments, the one or more commercials may be simultaneously provided to content consumption devices 108 of one or more disjoint time zones, e.g. to the eastern time zone and the pacific time zone.

Inventors of the present disclosure have discovered that online consumption of contents tend to peak at particular time intervals in the various time zones. Thus, simultaneously providing commercial messages to all content consumers of selected time zones at selected appointed times may be more cost effective than targeting individual content consumers, even though the commercials may not be of interest to a portion of the recipients. More importantly, increasingly content consumers may find the appearance of such commercials to be more user friendly, when they realize the benefits of regaining their privacy from not being tracked. Further, note that in embodiments a content consumer normally located in one time zone, will receive commercials along with the local content consumers, if he/she travels to another time zone. It is anticipated that a content consumer is likely to adapt his/her consumption behavior to the local time. For example, if a content consumer typically consumes content in the evening when the content consumer is at home, it is anticipated, the content consumer will likewise consume content in the evening of a local time, has the content consumer traveled to another time zone, e.g., from the eastern time zone to the pacific time zone.

In embodiments, commercial engine 117 may be configured to receive the appointed time selections, and the number or specific time zones from sponsors 109 of the commercial messages, such as advertisers and/or their agents. In embodiments, commercial engine 117 may be configured with default appointed times for various time zones, the default number or specific time zones to receive the commercial messages at the same time, negating the need for the sponsors 109 to provide the selections. Instead, sponsors 09 may rely on the expertise of the operator of commercial engine 117 instead. In embodiments, commercial engine 117 may be likewise configured to receive the commercial messages or their locators (e.g., uniform resource locations (URL)) of the commercial messages from sponsors 109. In embodiments, commercial engine 117 may be configured to store the received appointed time selections, the number or specific time zones, the commercial messages or their resource locators in storage 114. Any one of a number of databases and/or data structures may be employed to store these information/data.

In alternate embodiments, as described earlier, commercial engine 117 may simultaneously transmit the one or more commercials to content consumption devices 108 of one or more time zones, itself, as opposed to causing content provision engine 116 to do so. In embodiments, commercial engine 117 may simultaneously transmit the one or more commercials to IP addresses of content consumption devices 108 currently receiving streaming from content provision engine 116. In embodiments, commercial engine 117 and content provision engine 116 may be configured such that commercial engine 117 may obtain these IP addresses from content provision engine 116.

In embodiments, content provision engine 116 and/or commercial engine 117 may be configured to gather and report viewership of the commercial messages to sponsors 109. In embodiments, the viewership information may be grouped by contents, time zones, as well as other factors. In embodiments, the viewership information may be reported real time. In embodiments, commercial engine 117 may be configured to invoice advertisers and/or agents 109 for the transmission of the commercial messages, based at least in part on the reported viewership. The unit price per viewer may be agreed to between the operator of commercial server 105 and sponsors 109 in advance. The unit price may vary for different appointed times.

In still other embodiments, commercial engine 117 may be configured to publish historic viewership of various appointed times, and auction the appointed times to sponsors 109.

Before further describing the present disclosure, while for ease of understanding, commercial engine 117 and storage 115 are shown as disposed on commercial server 105, separate from content aggregation/distribution servers 104, in embodiments, commercial server 105 and content aggregation/distribution servers 104 may be combined, with storage 114 and 115 combined, and commercial engine 117 disposed on one or more content aggregation/distribution servers 104 instead.

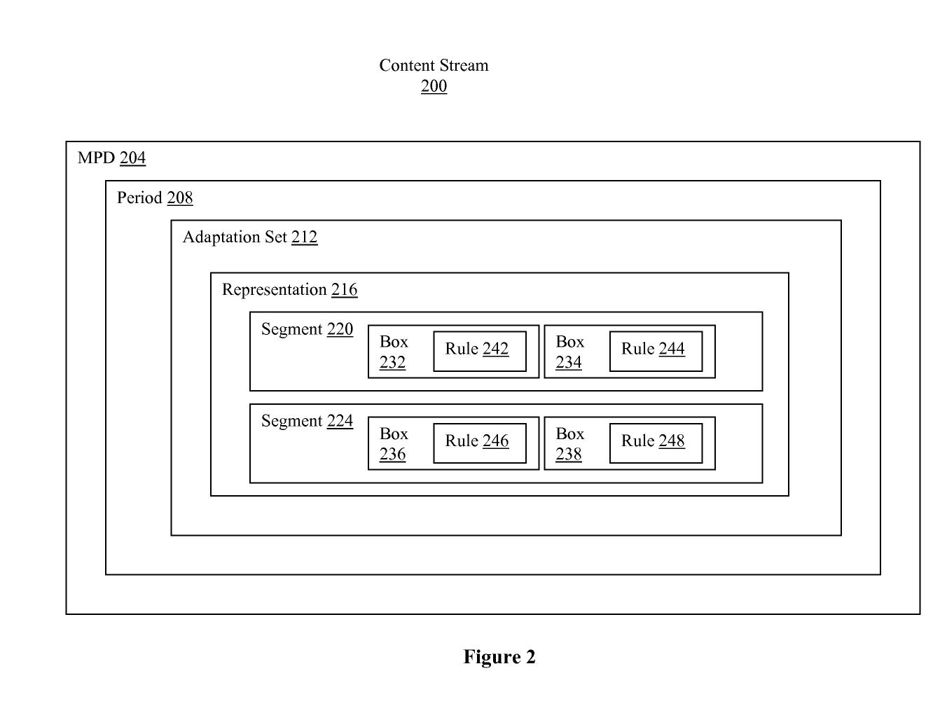

Referring now also to FIG. 2, wherein an example content stream, in accordance with various embodiments, is illustrated. Each content stream 200 may be divided into discrete segments which can then be selectively requested by the content consumption device 108. For example, the content consumption device 108 may send a request via hypertext transfer protocol (HTTP) or some other internet protocol to a server such as a content aggregation/distribution server 104. The content aggregation/distribution server 104 may respond by providing the requested segment.

In embodiments, the encoded content stream 200 may include a media presentation description (MPD) 204 document. The MPD 204 may describe a sequence of periods 208 that represent a content period during which a consistent set of encoded versions of the content is available. In other words, the set of available bitrates, languages, captions, subtitles, or other QoS parameters or QoS levels may remain unchanged during the period 208. Although only a single period 208 is depicted in FIG. 2, other embodiments may have an MPD 204 with multiple periods, each having different available bitrates, languages, captions, subtitles, or other QoS parameters or QoS levels. In embodiments, the captions may be in multiple languages.

Within a period 208, the content may be arranged into adaptation sets 212. The adaptation set 212 may represent a set of interchangeable encoded versions of one or several content components such as a video component, an audio component, etc. Other components such as captions or audio descriptions may likewise have a separate adaptation set 212. Although only a single adaptation set 212 is shown in FIG. 2, in other embodiments each period 208 may comprise a plurality of adaptation sets 212.

Each adaptation set 212 may comprise one or more representations 216. A representation may describe the deliverable encoded versions of one or several content components of the content 102 or secondary content, such as commercials/advertisements, interleaved in between segments of the primary content. For example, a representation 216 may include one or more streams for each content component such as audio components, video components, captions, or audio descriptions of the primary or secondary content. In general, any single representation 216 within an adaptation set 212 may be sufficient to render the contained content components. In embodiments, each adaptation set 212 may include a plurality of representations 216.

Each representation 216 may be divided into one or more segments 220 and 224. In general, a segment 220 and 224 may be considered to be the largest unit of the encoded content 200 that may be retrieved by a single HTTP request. In embodiments, the segment 220 may have a different length or duration than segment 224. In some embodiments, the segment length may vary between representations such that the length of segment 220 and 224 in representation 216 may be on the order of a few seconds, while in another representation the length of a segment may be as long as the length of the representation or some value in between.

In embodiments, each segment such as segment 220 or segment 224 may be encoded according to an ISO base media file format such as that defined in ISO/IEC 14496-12:2012. Specifically, each segment such as segment 220 or segment 224 may comprise a plurality of boxes 232 and 234 or 236 and 238 respectively. In some embodiments the boxes 232-238, may comprise one or more presentation rules 242-248, that governs the presentation of one or more segments. The rules may also be referred as policies. In embodiments, the rules or policies may be provided to the content consumption devices separately (as opposed to integrally), via e.g., a manifest, separate from the content stream. In either case, decoder 132, or some other component, may be configured to receive the policies separately or extract the policies from the content stream, and process them for use by presentation engine 134. Typically, associated policies integrally provided with the content stream may govern only presentation of the content stream. On the other hand, associated policies separately provided, e.g., in advance, may govern presentation of multiple content streams.

Referring back to FIG. 1, networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which servers 104 go through to communicate with content consumption devices 108. Similarly, at the content consumption end, networks 106 may include base stations and/or access points, through which consumption devices 108 communicate with servers 104. In between the two ends may be any number of network routers, switches and other networking equipment of the like. However, for ease of understanding, these gateways, firewalls, routers, switches, base stations, access points and the like are not shown.

Continuing to refer to FIG. 1, in embodiments, as shown, a content consumption device 108 may include player 122, display 124 and user input device 126. Player 122 may be configured to receive streamed content, decode and recovered the content from the content stream, and present the recovered content on display 124, in response to user selections/inputs from user input device 126. Further, player 122 may be configured to receive the commercial messages, decode and recovered the commercial messages, if encoded, and present the (recovered) commercial messages on display 124.

In embodiments, player 122 may include decoder 132, presentation engine 134 and user interface engine 136. Decoder 132 may be configured to receive streamed content, decode and recover the content from the content stream. Decoder 132 may also be configured to receive the commercial messages, decode and recover the commercial messages, if they are encoded. Presentation engine 134 may be configured to present the recovered content on display 124, in response to user selections/inputs. Presentation engine 134 may be configured to also present the (recovered) commercial messages on display 124. User interface engine 136 may be configured to receive the user selections/inputs from a user.

While shown as part of a content consumption device 108, display 124 and/or user input device(s) 126 may be standalone devices or integrated, for different embodiments of content consumption devices 108. For example, for a television arrangement, display 124 may be a stand-alone television set, Liquid Crystal Display (LCD), Plasma and the like, while player 122 may be part of a separate set-top set, and other user input device 126 may be a separate remote control or keyboard. Similarly, for a desktop computer arrangement, player 122, display 124 and other input device(s) 126 may all be separate stand alone units. On the other hand, for a laptop, ultrabook, tablet or smartphone arrangement, player 122, display 124 and other input devices 126 may be integrated together into a single form factor. Further, for tablet or smartphone arrangement, a touch sensitive display screen may also server as one of the other user input device(s) 126, and player 122 may be a computing platform with a soft keyboard that also include one of the user input device(s) 126.

In embodiments, the various elements illustrated in FIG. 1 may be implemented in hardware and/or software. In the case of software implementations, the elements may be implemented in any one of a number of high level languages with compiler supports to compile the high level language implementations into instructions of the instruction set architectures supported by the underlying processors or processor cores of the various servers/devices.

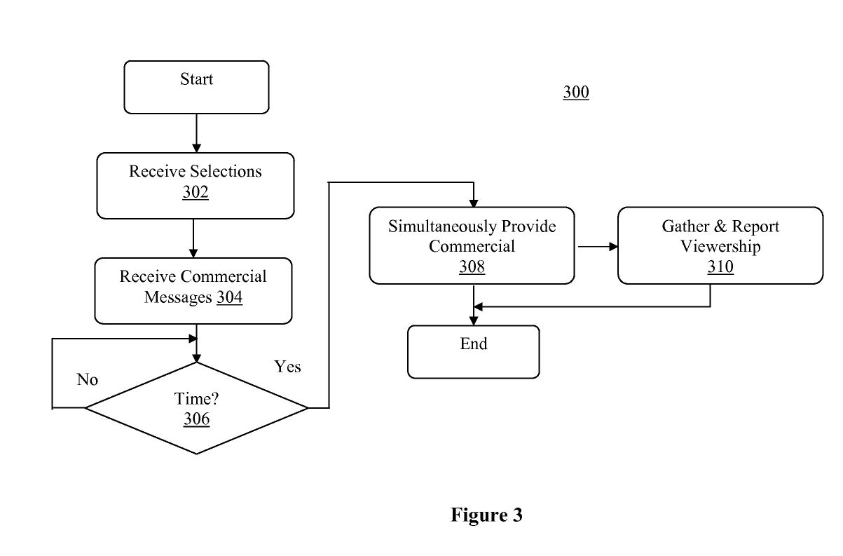

Referring now to FIG. 3, wherein an example process for simultaneously providing commercials, in accordance with various embodiments, is illustrated. As shown, process 300 may include operations in blocks 302-310. These operations may be performed, e.g., by the earlier described commercial engine 117 of FIG. 1, alone or in cooperation with content provision engine 116.

As shown, process 300 may start at block 302, where appointed time and/or time zone selections for simultaneous commercial provision of various commercial messages may be received from the various sponsors 109, e.g., by commercial engine 117, and subsequently, by content provision engine 116, depending on whether the commercial messages are to be simultaneously provided by commercial engine 117 or content provision engine 116. On receipt, the appointed times and/or time zones of the various commercial messages may be respectively stored, e.g., in storage 115 and/or 114. In embodiments, the information may be provided to content provision engine 116 by commercial engine 117.

From block 302, process 300 may proceed to block 304. In block 304, commercial messages or their resource locators may be received from sponsors 109, e.g., by commercial engine 117, and subsequently, by content provision engine 116, depending on whether the commercial messages are to be simultaneously provided by commercial engine 117 or content provision engine 116. Similarly, on receipt, the commercial messages and/or their resource locators may be respectively stored, e.g., in storage 115 and/or 114. In embodiments, the commercial messages and/or their resource locators may be provided to content provision engine 116 by commercial engine 117.

From block 304, process 300 may proceed to block 306. At block 306, process 300 may determine whether one of the appointed times has been reached, e.g., by commercial engine 117 or content provision engine 116. If not, process 300 may remain at 306, and have the determination repeated. The frequency of repeating determination may be application dependent. Eventually, a selected appointed time of a commercial message may be reached.

At such time, process 300 may proceed to block 308. At block 308, process 300 may transmit the commercial messages to content consumption devices 108 of the applicable time zones, e.g., by commercial engine 117 or content provision engine 116. In embodiments, as described earlier, process 300 may transmit directly the commercial messages to IP addresses of content consumption devices 108 of the applicable time zones. In embodiments, the IP addresses may be obtained from a component streaming content to the various content consumption devices 108 of the applicable time zones, e.g., content provision engine 116. As described, the commercial messages may be provided without regard to the content being consumed by various content consumption devices 108, the demographics and/or interests of the content consumers of content consumption devices 108. From block 308, process 300 may proceed to the “end” block, where the process may end.

In embodiments, from block 308, process 300 may proceed to the next block, block 310 instead. At block 310, process 300 may gather and report on viewership for the transmitted commercial message, before proceeding the “end” block, where the process may end. As described earlier, the viewership information gathered and reported may be grouped by time zones, contents, and/or other factors. Further, the gathering and reporting of viewership information may be performed in real time. At block 310, process 300 may invoice sponsors 109, for the transmission of the commercial message, based at least in part on the reported viewership.

In alternate embodiments, operator of commercial engine 117 may have default appointed times selected for the various time zones. Commercial engine 117 may publish historic viewership for the various appointed times of the various time zones. In these embodiments, sponsors 109 may select from the list of appointed times when commercial engine 117 would simultaneously provide commercial messages. In embodiments, commercial engine 117 may have a number of appointed time slots, variable priced and/or available for the sponsors 109 to bid for the appointed times. In other words, commercial engine 117 may auction the appointed times to sponsors 109. In embodiments, commercial engine 117 may monitor the network traffic to determine the IP addresses. In embodiments, commercial engine 117 may segregate the IP addresses into IP addresses of different zones, based on the IP addresses themselves.

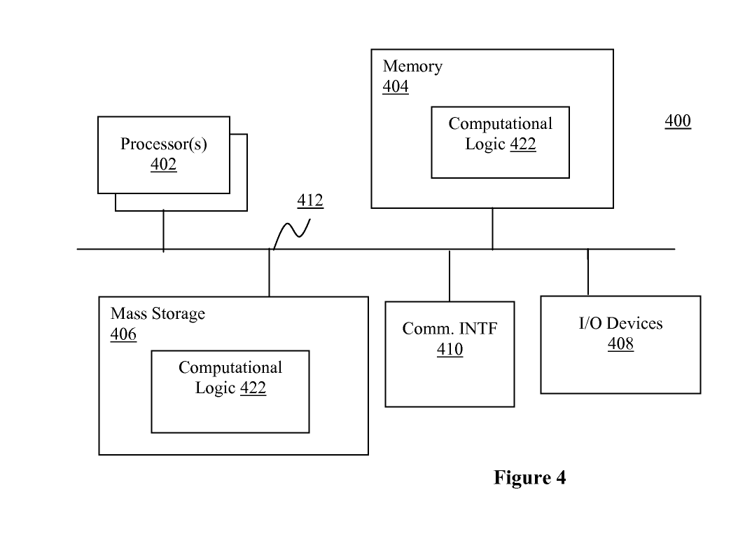

Referring now to FIG. 4, wherein an example computer suitable for use for the arrangement of FIG. 1, in accordance with various embodiments, is illustrated. As shown, computer 400 may include one or more processors or processor cores 402, and system memory 404. For the purpose of this application, including the claims, the terms “processor” and “processor cores” may be considered synonymous, unless the context clearly requires otherwise. Additionally, computer 400 may include mass storage devices 406 (such as diskette, hard drive, compact disc read only memory (CD-ROM) and so forth), input/output devices 408 (such as display, keyboard, cursor control and so forth) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage devices 406 may be employed to store a working copy and a permanent copy of the programming instructions implementing the operations associated with content provision engine 116 and/or commercial engine 117, earlier described, collectively referred to as computational logic 422. The various elements may be implemented by assembler instructions supported by processor(s) 402 or high-level languages, such as, for example, C, that can be compiled into such instructions.

The permanent copy of the programming instructions may be placed into permanent storage devices 406 in the factory, or in the field, through, for example, a distribution medium (not shown), such as a compact disc (CD), or through communication interface 410 (from a distribution server (not shown)). That is, one or more distribution media having an implementation of the agent program may be employed to distribute the agent and program various computing devices.

The number, capability and/or capacity of these elements 410-412 may vary, depending on whether computer 400 is used as a content aggregation/distribution server 104 or a content consumption device 108. When use as content consumption device, whether the content consumption device is a stationary or mobile device, like a smartphone, computing tablet, ultrabook or laptop. Their constitutions are otherwise known, and accordingly will not be further described.

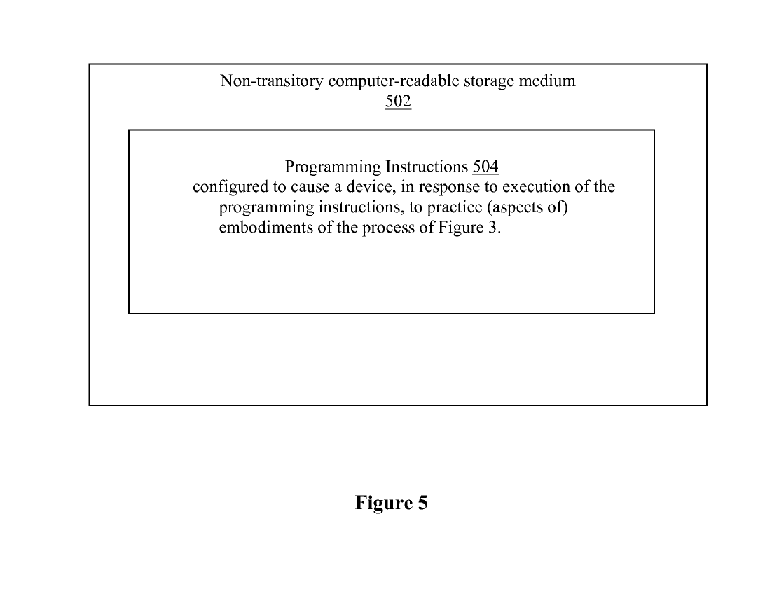

FIG. 5 illustrates an example computer-reader non-transitory computer-readable storage medium having instructions configured to practice all or selected ones of the operations associated with content aggregation/distribution servers 104 or commercial server 105, earlier described; in accordance with various embodiments. As illustrated, non-transitory computer-readable storage medium 502 may include a number of programming instructions 504. Programming instructions 504 may be configured to enable a device, e.g., computer 400, in response to execution of the programming instructions, to perform, e.g., various operations of process 300 of FIG. 3, e.g., but not limited to, the operations performed in association with simultaneous provision of commercial messages at appointed times, across multiple contents. In alternate embodiments, programming instructions 504 may be disposed on multiple non-transitory computer-readable storage media 502 instead. In embodiments, the instructions may be encoded in a transitory storage medium, such as a signal.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. At least one computer readable non-transitory storage medium comprising a plurality of instructions, configured to cause a computing system, in response to execution of the instructions by the computing system to:
stream a plurality of multi-media content, via one or more networks, to a plurality of content consumption devices of a plurality of content consumers currently located at a plurality of time zones; and
at an appointed time of a first of the plurality of time zones, transmit a commercial message to at least the content consumption devices of the content consumers currently located in a second time zone, irrespective of whether the content consumers of the content consumption devices to receive the commercial message are consuming the same or different content from one or more media content distribution systems.

2. The storage medium of claim 1, wherein transmit further comprises transmit the commercial message to at least the content consumption devices of the content consumers currently located a second time zone, irrespective of demographics of the content consumers of the content consumption devices.

3. The storage medium of claim 1, wherein transmit further comprises transmit the commercial message to at least the content consumption devices of the content consumers currently located a second time zone, irrespective of interests of the content consumers of the content consumption devices.

4. The storage medium of claim 1, wherein the commercial message comprises multi-media content.

5. The storage medium of claim 1, wherein the instructions, in response to execution by the computing system, further cause the computing system to receive a selection of the appointed time, and determine whether the appointed time has been reached.

6. The storage medium of claim 5, wherein receive a selection comprises receive the selection from another computing system associated with a simultaneous commercial service, or a sponsor of the commercial message.

7. The storage medium of claim 6, wherein the instructions further cause the computing system to receive the commercial message from the other computing system associated with the simultaneous commercial service, or the sponsor.

8. The storage medium of claim 1, wherein the instructions, in response to execution by the computing system, further cause the computing system to determine current IP addresses of at least the content consumption devices currently located in the second time zone; wherein transmit comprises transmit packets of the commercial message to the current IP addresses determined for the content consumption devices.

9. The storage medium of claim 1, wherein the first and second time zones are the same time zone.

10. The storage medium of claim 1, wherein transmit further comprises transmit the commercial message to content consumption devices currently located in a third time zone adjacent to the first/second same time zone.

11. The storage medium of claim 10, wherein the instructions, in response to execution of the instructions by the computing system, further cause the computing system to receive a selection of a number of time zones, within which the content consumption devices receiving streaming of content at the appointed time, are to receive the commercial.

12. The storage medium of claim 1, wherein at least one of the content consumption devices currently located in the second time zone, is normally located at a different time zone at the appointed of the first time zone.

13. The storage medium of claim 1, wherein the instructions further cause the computing system to gather and report viewership of the transmitted commercial message to a simultaneous commercial service, or a sponsor of the commercial message.

14. The storage medium of claim 13, wherein the instructions further cause the computing system to invoice the sponsor for the transmission of the commercial message based on the viewership gathered and reported post transmission.

15. The storage medium of claim 14, wherein the instructions further cause the computing system to publish historic viewership of the appointed time, and auction the appointed time to one of a plurality of sponsors of commercial messages.

16. An apparatus comprising:
a commercial engine configured to transmit or cause a content provision engine, configured to stream a plurality of multi-media content, via one or more networks, to a plurality of content consumption devices of a plurality of content consumers currently located at a plurality of time zones, to transmit, at an appointed time of a first of the plurality of time zones, a commercial message to at least the content consumption devices of the content consumers currently located a second time zone, irrespective of whether the content consumers of the content consumption devices to receive the commercial message are consuming the same or different content from one or more media content distribution systems.

17. The apparatus of claim 16, wherein the commercial engine is further configured to transmit or cause the content provision engine to transmit the commercial message to at least the content consumption devices of the content consumers currently located a second time zone, irrespective of demographics of the content consumers of the content consumption devices.

18. The apparatus of claim 16, wherein the commercial engine is further configured to transmit or cause the content provision engine to transmit the commercial message to at least the content consumption devices of the content consumers currently located a second time zone, irrespective of interests of the content consumers of the content consumption devices.

19. The apparatus of claim 16, wherein the commercial engine is further configured to receive a selection of the appointed time, and determine whether the appointed time has been reached.

20. The apparatus of claim 19, wherein the commercial engine is further configured to receive the selection from another computing device associated with a sponsor of the commercial message.

21. The apparatus of claim 16, wherein the commercial engine is further configured to receive a selection of a number of time zones, within which the content consumption devices receiving streaming of content at the appointed time, are to receive the commercial.

22. The apparatus of claim 21, wherein the number of time zones comprises at least two time zones, explicitly or implicitly including the first and second time zones, which are adjacent time zones, and wherein the commercial engine is further configured to cause the content provision engine to transmit the commercial message to content consumption devices currently located in at least the first and second adjacent time zone.

23. The apparatus of claim 16, wherein the commercial engine is configured to receive IP addresses of the content consumption devices of at least the second time zone, and at the appointed time of the first time zone, transmit the commercial message to at least the content consumption devices of the content consumers currently located in the second time zone, at the IP addresses received.

24. The apparatus of claim 16, wherein the commercial engine is further configured to gather and report viewership of the transmitted commercial message to a sponsor of the commercial message.

25. The apparatus of claim 24, wherein the commercial engine is further configured to invoice the sponsor for the transmission of the commercial message based on the viewership gathered and reported post transmission.

26. The apparatus of claim 24, wherein the commercial engine is further configured to publish historic viewership of the appointed time, and auction the appointed time to one of a plurality of sponsors of commercial messages.

27. A method comprising:
streaming a plurality of multi-media content, by a content distribution system, via one or more networks, to a plurality of content consumption devices of a plurality of content consumers currently located at a plurality of time zones; and
at an appointed time of a first of the plurality of time zones, transmitting a commercial message to at least the content consumption devices of the content consumers currently located a second time zone, irrespective of whether the content consumers of the content consumption devices receiving the commercial message are consuming the same or different content from the content distribution system or one or more other content distribution system.

28. The method of claim 27, wherein transmitting further comprises transmitting the commercial message to at least the content consumption devices of the content consumers currently located a second time zone, irrespective of demographics or interest of the content consumers of the content consumption devices.

29. The method of claim 27, further comprising receiving a selection of the appointed time, and determining whether the appointed time has been reached.

30. The method of claim 29, wherein receiving a selection comprises receiving the selection from a computing device associated with a simultaneous commercial service, or a sponsor of the commercial message; wherein the method further comprises receiving the commercial message from the computing device associated with the simultaneous commercial service, or the sponsor.

31. The method of claim 27, further comprising gathering and reporting viewership of the transmitted commercial message to a simultaneous commercial service, or a sponsor of the commercial message.

32. The method of claim 31, further comprising invoicing the sponsor for the transmission of the commercial message based on the viewership gathered and reported post transmission.

33. The method of claim 31, further comprising publishing historic viewership of the appointed time, and auctioning the appointed time to one of a plurality of sponsors of commercial messages.
